(19) United States
(12) Patent Application Publication
(10) Pub. No.: US 2026/0158638 A1
(43) Pub. Date: Jun. 11, 2026

(54) Rotary Worktable with a Cooling Circuit

(71) Applicant: HIWIN TECHNOLOGIES CORP., Taichung City (TW)

(72) Inventors: Yuan-Tai CHANG, Taichung City (TW); Yu-Ju LIN, Taichung City (TW)

(21) Appl. No.: 18/971,613

(22) Filed: Dec. 6, 2024

(51) Int. Cl. B25H 1/02

(52) U.S. Cl. CPC B25H 1/02

(57) ABSTRACT

A rotary worktable with a cooling circuit, includes: a spindle formed along an axial direction and including plural flow channel inlet sections, plural first flow channel sections connected to the flow channel inlet sections and arranged around the axial direction, a flow channel outlet section connected to the first flow channel sections, and a first recirculation section parallel to the axial direction and having a first recirculation inlet and a first recirculation outlet at two ends; and a turntable locked with the spindle and including a second flow channel section connected to the flow channel outlet, a cooling chamber connected to the second flow channel section, and a second recirculation section connected between the cooling chamber and the first recirculation inlet. When the rotary worktable operates at high speed, the heat generated by components such as seals, brakes and bearings is effectively removed to maintain normal and efficient operation.

### BACKGROUND

### Field of the Invention

The present invention relates to the rotary worktable for metal processing equipment, and more particularly to a rotary worktable with a cooling circuit.

### Description of Related Art

In order to meet the process requirements of various industries and the requirements of high-speed continuous operation, the rotary worktable used in traditional metal processing equipment (such as milling machines and lathes) is usually designed with a central oil outlet function to supply the medium to the clamping fixture. However, under continuous high-speed operation, the friction between the spindle and the sealing element will generate heat, causing the temperature to rise, which in turn affects the normal operation of the internal mechanism (such as bearings and brakes), and may cause the components to get stuck or fail.

To this end, the industry has developed a variety of cooling designs for rotary worktables, such as a rotary worktable device with a cooling structure and a rotary bearing with a cooling structure provided by the patent CN101959640A of mainland China. However, this patent uses a rotary joint to transport the medium, which increases the number of parts and occupies the central oil outlet function of the workbench. In addition, the blower blades and radiator design used in the patent occupy a large amount of space, and the air cooling medium has poor thermal conductivity, resulting in poor cooling effect.

Another example is a rotary splitting device for a working machine provided by Japanese patent JP2009166196A. However, this patent only considers the function of the distributor and does not plan for the heating problem during high-speed operation. Therefore, this technology is only applicable to intermittent and low-speed motion scenarios.

### SUMMARY

The object of the present invention is to provide a rotary worktable with a cooling circuit that can solve one of the above-mentioned problems.

To achieve the above object, the present invention provides a rotary worktable with a cooling circuit, which comprises: a spindle formed along an axial direction and including a plurality of flow channel inlet sections, a plurality of first flow channel sections respectively connected to the flow channel inlet sections and arranged around the axial direction, a flow channel outlet section connected to the respective first flow channel sections, and a first recirculation section parallel to the axial direction, wherein two ends of the first recirculation section are respectively a first recirculation inlet and a first recirculation outlet; and a turntable locked with the spindle and including a second flow channel section connected to the flow channel outlet, a cooling chamber connected to the second flow channel section, and a second recirculation section connected between the cooling chamber and the first recirculation inlet.

The effect of the present invention lies in that: the spindle of the present invention is provided with the structure of the plurality of first flow channel sections around the axial direction, coupled with the cooling chamber of the turntable and the flow channel section design therebetween, an effective cooling circuit is formed, so that the seals and the brake of the rotary worktable are within the length range of the first flow channel section, and the bearing of the rotary worktable corresponds to the cooling chamber. This design can effectively remove the heat generated by the seals, the brake and the bearing when the rotary worktable is running at high speed, thereby suppressing the temperature rise of the entire rotary worktable to maintain the normal operation of the rotary worktable, and at the same time ensure that it can still maintain stable performance under long-term high-load operation, improve the operating efficiency of the rotary worktable, and also enhance its service life.

Additionally, since the present invention is to design a cooling circuit for the original spindle and turntable of the rotary worktable, no additional heat-dissipating components are introduced, and the space occupied by the rotary worktable is not increased.

Preferably, the spindle further includes a top surface and an annular side surface, each of the flow channel inlet sections includes a flow channel inlet located on the annular side surface, the flow channel outlet section includes a plurality of outlet flow sections respectively connected to the first flow channel sections and arranged in a radial pattern, and a converging flow section connected to the respective outlet flow sections, and the converging flow section has a flow channel outlet located on the top surface and connected to the second flow channel section.

Preferably, the cooling chamber is annular or spiral-shaped and includes a first chamber port connected to the second flow channel section, and a second chamber port far from the first chamber port and connected to the second recirculation section.

Preferably, the spindle is pivoted on a distributor, a plurality of seals are arranged between the spindle and the distributor along the axial direction, and each of the seals is within a length range of each of the first flow channel sections.

Preferably, the distributor is embedded in a rotor, the rotor is embedded in a stator, a brake is arranged between the rotor and the stator, the brake is within a length range of each of the first flow channel sections, the turntable is pivotally mounted on a bearing seat by a bearing, and the bearing corresponds to the cooling chamber of the turntable.

Preferably, the first flow channel sections are spaced equidistantly around the axial direction.

To achieve the above object, the present invention provides another rotary worktable with a cooling circuit, which comprises: a spindle formed along an axial direction and including a first flow channel section, a plurality of first cooling chambers on the path of the first flow channel section and connected to the first flow channel section, and a first recirculation section parallel to the axial direction, the two ends of the first flow channel section are respectively a flow channel inlet and a flow channel outlet, the two ends of the first recirculation section are respectively a first recirculation inlet and a first recirculation outlet; and a turntable locked with the spindle, and including a second flow channel section connected to the flow channel outlet, a second cooling chamber connected to the second flow channel section, and a second recirculation section connected between the second cooling chamber and the first recirculation inlet.

The effect of the present invention lies in that: the present invention forms an effective cooling circuit by providing the first flow channel section and a plurality of first cooling chambers connected to the first flow channel section on the spindle, and the second cooling chamber of the turntable and the flow channel section design therebetween, so that each of the seals of the rotary worktable is located beside the corresponding one of the first cooling chambers, and the bearings of the rotary worktable correspond to the first cooling chambers. This design can effectively remove the heat generated by the seals, the bearings and other components when the rotary worktable is running at high speed, thereby suppressing the temperature rise of the entire rotary worktable to maintain the normal operation of the rotary worktable, while ensuring that it can still maintain stable performance under long-term high-load operation, thereby improving the operating efficiency of the rotary worktable and enhancing its service life.

Preferably, the spindle includes a spindle body and an annular sleeve sleeved on the spindle body.

Preferably, the first cooling chambers are arranged between the spindle body and the annular sleeve.

Preferably, the second cooling chamber is annular or spiral-shaped and includes a first chamber port connected to the second flow channel section, and a second chamber port far from the first chamber port and connected to the second recirculation section.

Preferably, the spindle is pivoted on a distributor, a plurality of seals are arranged between the spindle and the distributors along the axial direction, and each of the seals is located beside a corresponding one of the first cooling chambers.

Preferably, the turntable is pivotally mounted on a bearing seat by a bearing, and the bearing corresponds to the second cooling chamber of the turntable.

### BRIEF DESCRIPTION OF THE DRAWINGS

FIG. 1 is a three-dimensional view of a first embodiment of the present invention;

FIG. 2 is a sectional view of the first embodiment of the present invention;

FIG. 3A is a three-dimensional view of the first embodiment of the present invention, showing the three-dimensional state of the spindle;

FIG. 3B is a sectional view taken along the line 3B-3B in FIG. 3A;

FIG. 3C is a sectional view taken along the line 3C-3C in FIG. 3A;

FIG. 3D is a sectional view taken along the line 3D-3D in FIG. 3A;

FIG. 4 is a sectional view of a part of the first embodiment of the present invention;

FIG. 5 is a sectional view of a part of a second embodiment of the present invention;

FIG. 6 is a sectional view of a third embodiment of the present invention;

FIG. 7A is an exploded three-dimensional view of the third embodiment of the present invention, showing the disassembled state of the spindle;

FIG. 7B is a sectional view of the third embodiment of the present invention, showing the sectional state of the spindle; and

FIG. 8 is a sectional view of a part of the third embodiment of the present invention.

### DETAILED DESCRIPTION

Before the present invention is described in detail, it should be noted that in the following description, similar elements and parts are represented by the same numbers.

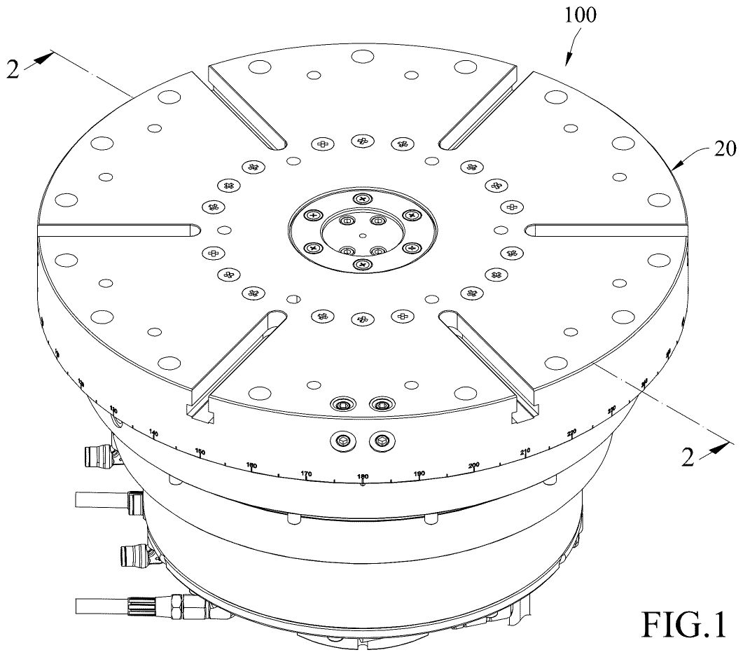

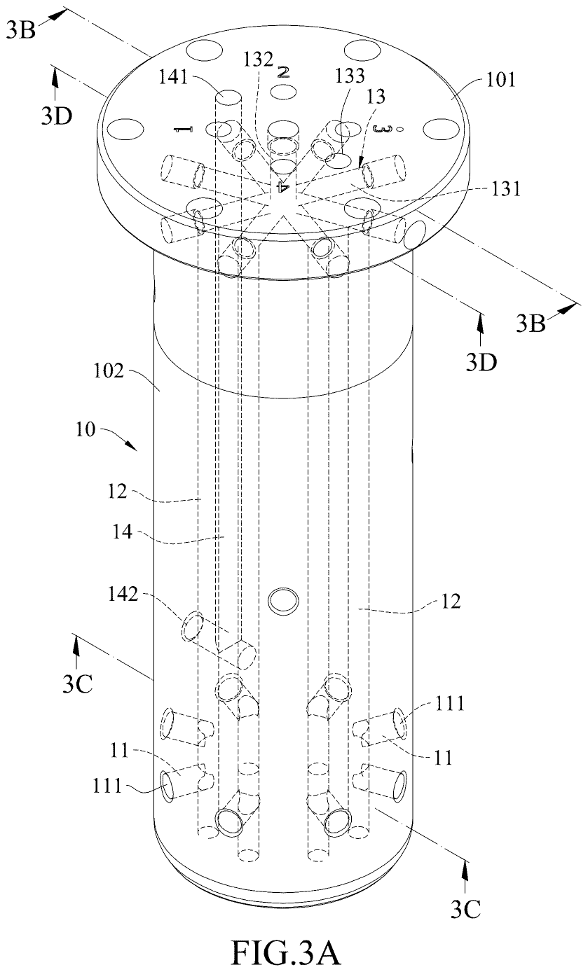

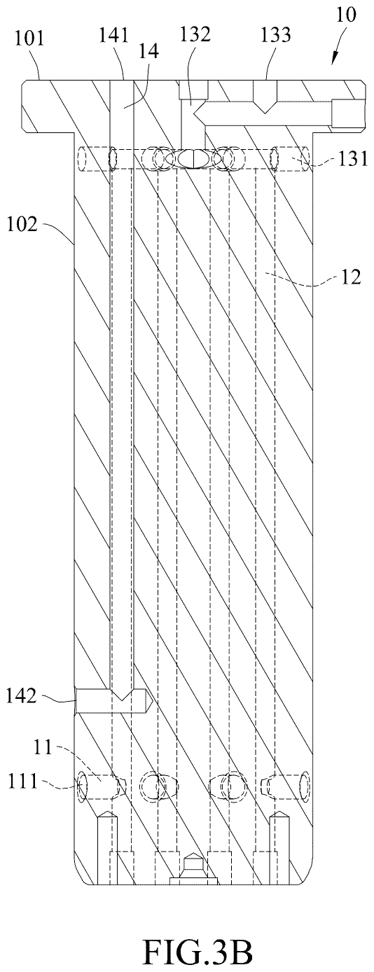

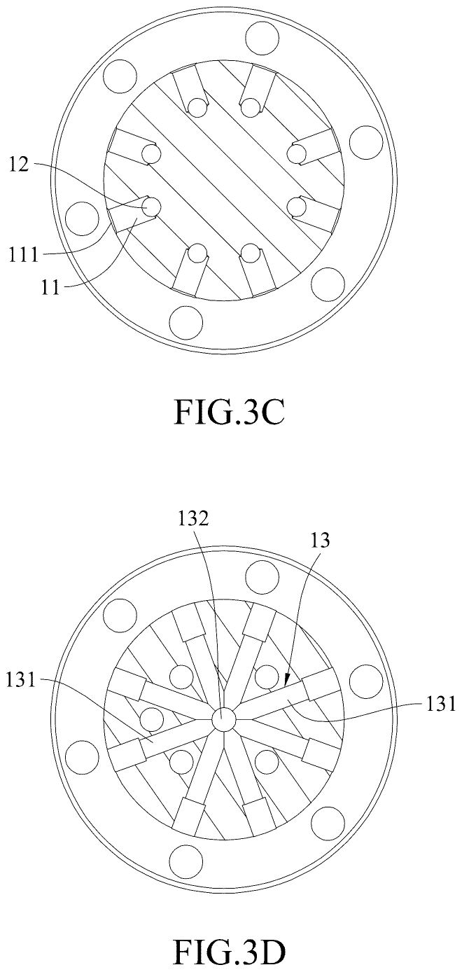

Referring to FIGS. 1 to 4, a rotary worktable 100 with a cooling circuit provided by the first embodiment of the present invention and essentially includes a spindle 10 and a turntable 20.

The spindle 10 is formed along an axial direction Y and has a plurality of flow channel inlet sections 11, a plurality of first flow channel sections 12 respectively connected to the flow channel inlet sections 11 and spaced equidistantly around the axial direction Y, a flow channel outlet section 13 connected to the respective first flow channel sections 12, and a first recirculation section 14 parallel to the axial direction Y, wherein two ends of the first recirculation section 14 are respectively a first recirculation inlet 141 and a first recirculation outlet 142; in this embodiment, the spindle 10 further includes a top surface 101 and an annular side surface 102, each of the flow channel inlet sections 11 is formed along a radial direction X and has a flow channel inlet 111 located on the annular side surface 102; the flow channel outlet section 13 includes a plurality of outlet flow sections 131 respectively connected to each of the first flow channel sections 12 along the radial direction X and arranged in a radial pattern, and a converging flow section 132 simultaneously connected to each of the outlet flow sections 131 along the axial direction Y, and the converging flow section 132 has a flow channel outlet 133 located on the top surface 101. In addition, the spindle 10 is pivoted on a plurality of distributors 30 arranged along the axial direction Y, and a plurality of seals 40 are arranged between the spindle 10 and the distributors 30 along the axial direction Y, and each of the seals 40 is within the length range of each of the first flow channel sections 12. At the same time, each of the distributors 30 is embedded in a rotor 50, and the rotor 50 is embedded in a stator 60, and a brake 70 is arranged between the rotor 50 and the stator 60, and the brake 70 is within the length range of each of the first flow channel sections 12. That is, the length range of each of the first flow channel sections 12 along the axial direction Y covers each of the seals 40 and the brake 70.

The turntable 20 is locked with the spindle 10 and includes a second flow channel section 21 connected to the flow channel outlet 133, a cooling chamber 22 connected to the second flow channel section 21, and a second recirculation section 23 connected between the cooling chamber 22 and the first recirculation inlet 141; in this embodiment, one end of the second flow channel section 21 is connected to the flow channel outlet 133 on the top surface 101, and the other end of the second flow channel section 21 is connected to the cooling chamber 22; the cooling chamber 22 is annular and includes a first chamber port 221 connected to the second flow channel section 21, and a second chamber port 222 far from the first chamber port 221 and connected to the second recirculation section 23, so that the length of the path of the cooling liquid flowing from the first chamber port 221 into the cooling chamber 22 and flowing out from the second chamber port 222 is the longest to obtain the best cooling effect. In addition, the turntable 20 is pivotally mounted on a bearing seat 90 by a bearing 80, and the bearing 80 corresponds to the cooling chamber 22 of the turntable 20.

The above is a configuration description of the main components of the first embodiment of the present invention. The operation mode and effect of the present invention are described as follows.

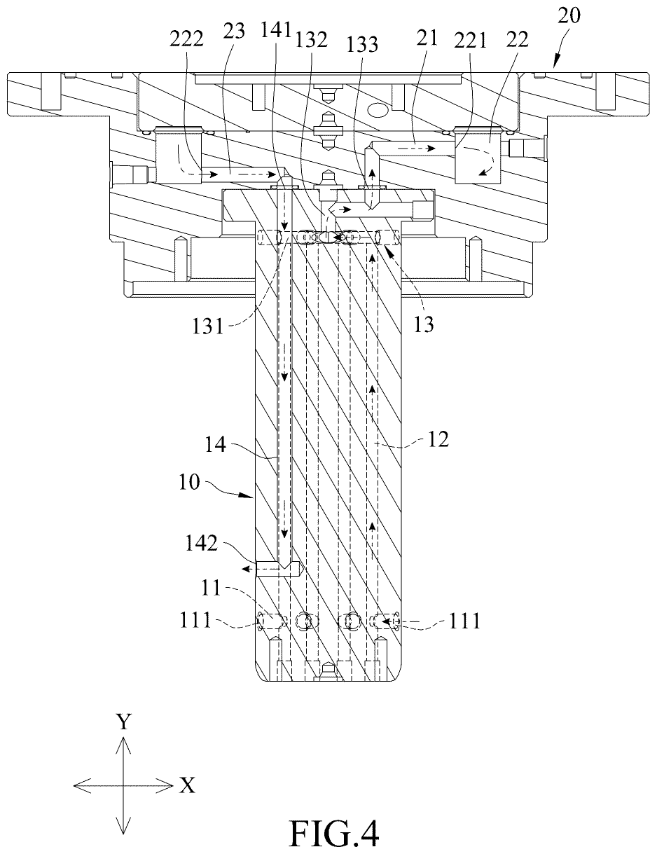

Referring to FIG. 4, it should be noted that the cooling circuit of the present invention is formed by the flow channel inlet section 11 of the spindle 10, the first flow channel sections 12 of the spindle 10, the flow channel outlet section 13 of the spindle 10, the second flow channel section 21 of the turntable 20, the cooling chamber 22 of the turntable 20, the second recirculation section 23 of the turntable 20, and the first recirculation section 14 of the spindle 10.

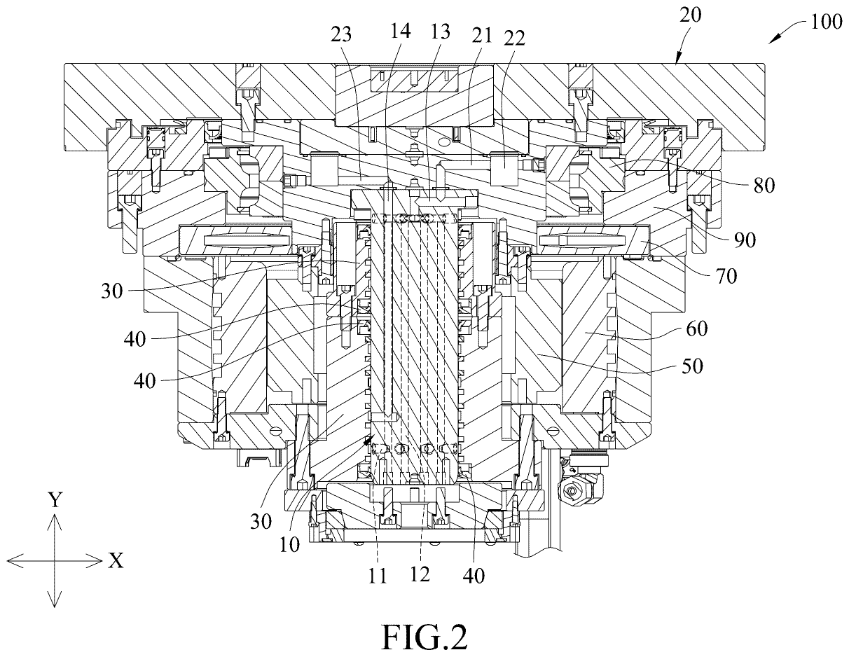

Referring to FIG. 2 and FIG. 4, the cooling liquid (as indicated by the arrow) of the cooling circuit flows in a path such that the cooling liquid first flows from the flow channel inlet 111 of each flow channel inlet section 11 into the interior of the spindle 10 along the radial direction X, and flows along the first flow channel sections 12 along the axial direction Y. The cooling liquid then flows along the radial direction X into each of the outlet flow sections 131, and after being gathered, flows through the converging flow section 132 along the axial direction Y or the radial direction X, and flows out of the spindle 10 from the flow channel outlet 133 and flows into the interior of the turntable 20 from the second flow channel section 21. After entering the turntable 20, the cooling liquid flows into the cooling chamber 22 of the turntable 20 along the radial direction X, and flows in a ring shape in the cooling chamber 22, and then flows out from the second recirculation section 23 of the turntable 20, and then flows back to the interior of the spindle 10 through the first recirculation section 14. Finally, the cooling liquid flows out through the first recirculation outlet 142 of the spindle 10, completing the entire cooling liquid circulation process.

It can be seen that the spindle 10 of the present invention is provided with the structure of the plurality of first flow channel sections 12 around the axial direction Y, coupled with the cooling chamber 22 of the turntable 20 and the flow channel section design therebetween, an effective cooling circuit is formed, so that the seals 40 and the brake 70 of the rotary worktable 100 are within the length range of the first flow channel section 12, and the bearing 80 of the rotary worktable 100 corresponds to the cooling chamber 22. This design can effectively remove the heat generated by the seals 40, the brake 70 and the bearing 80 when the rotary worktable 100 is running at high speed, thereby suppressing the temperature rise of the entire rotary worktable 100 to maintain the normal operation of the rotary worktable 100, and at the same time ensure that it can still maintain stable performance under long-term high-load operation, improve the operating efficiency of the rotary worktable 100, and also enhance its service life.

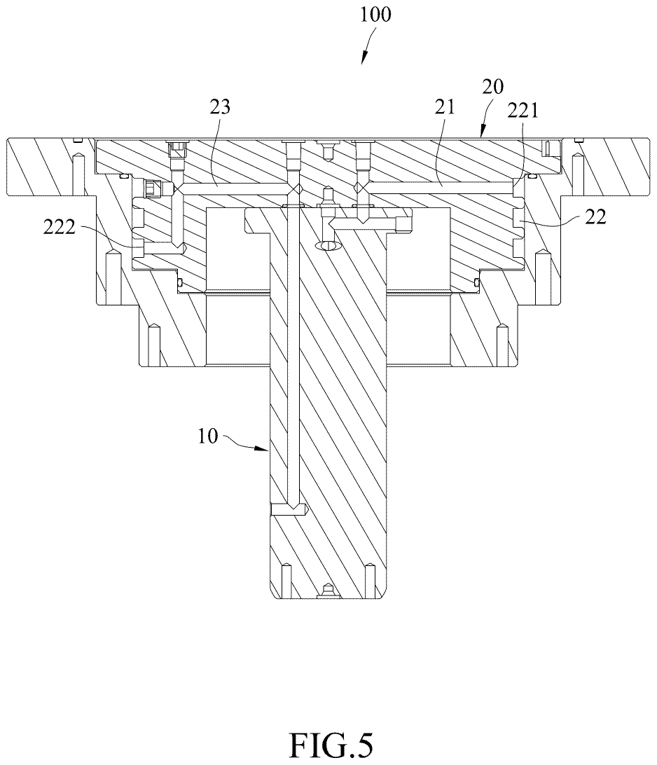

Referring to FIG. 5, a rotary worktable 100 with a cooling circuit provided by a second embodiment of the present invention and also essentially includes a spindle 10 and a turntable 20. The second embodiment is different from the first embodiment in that:

The cooling chamber 22 of the turntable 20 is spiral-shaped and includes a first chamber port 221 connected to the second flow channel section 21 and located at the uppermost end of the cooling chamber 22, and a second chamber port 222 located away from the first chamber port 221 and connected to the second recirculation section 23 and located at the lowermost end of the cooling chamber 22; By designing the cooling chamber 22 in a spiral shape, when the cooling liquid flows into the cooling chamber 22, it flows in a spiral path with a longer flow path, effectively taking away heat, thereby suppressing the temperature rise of the entire rotary worktable 100 and better maintaining the normal operation of the rotary worktable 100.

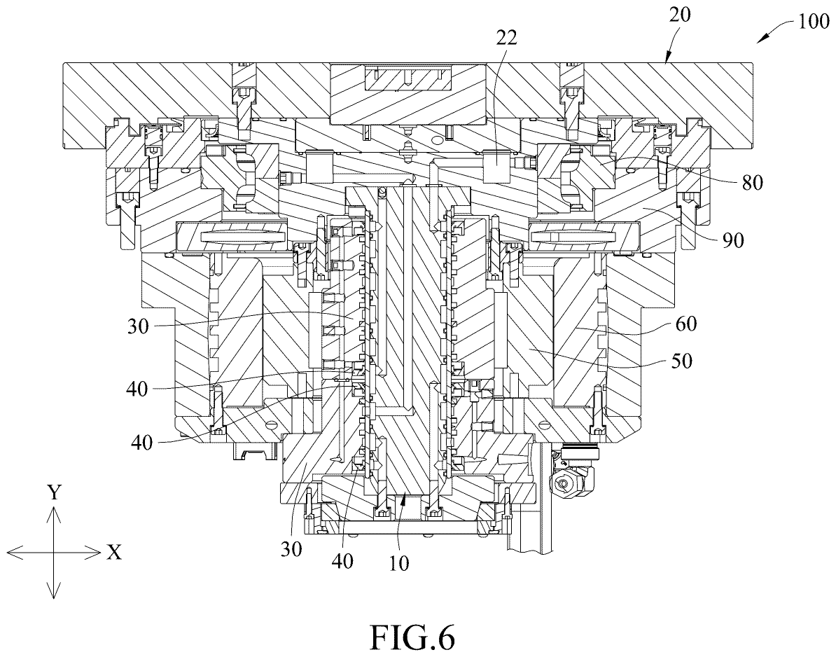

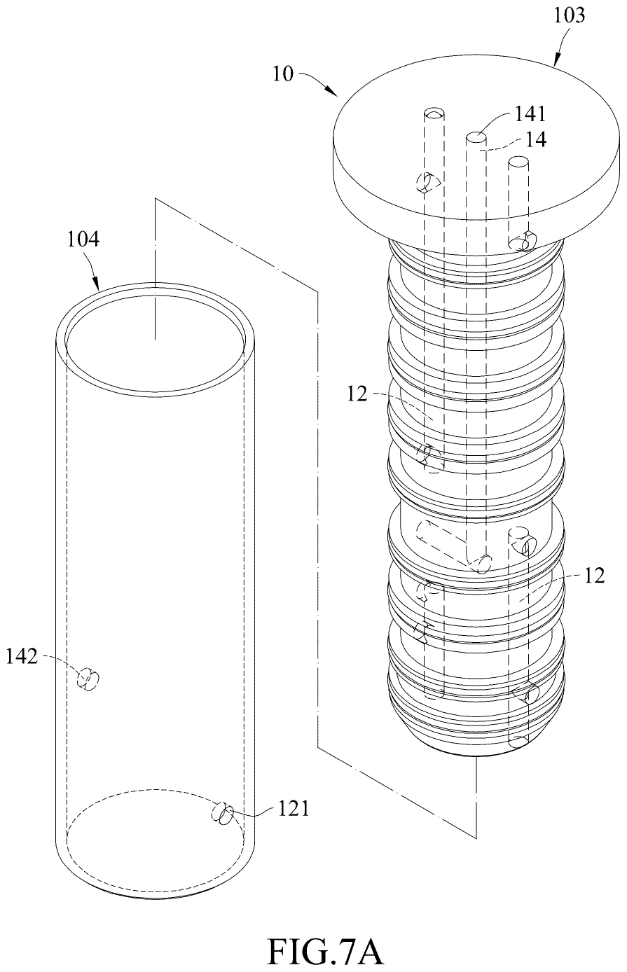

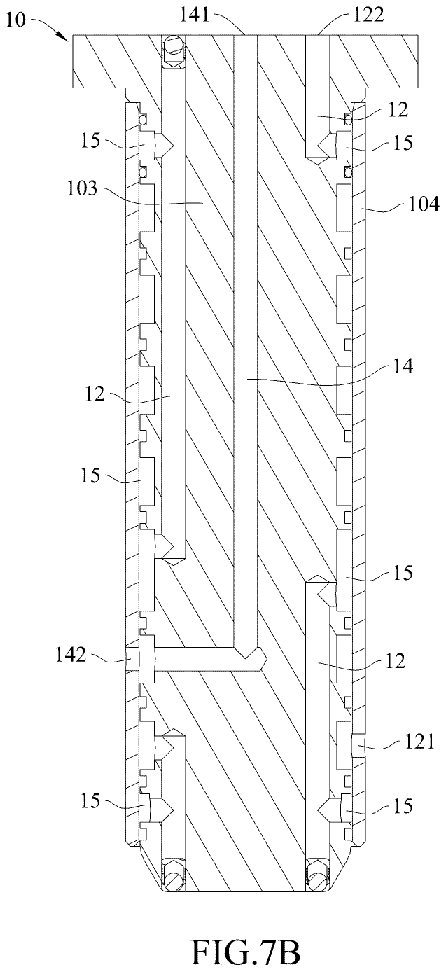

Referring to FIGS. 6 to 8, a rotary worktable 100 with a cooling circuit provided by a third embodiment of the present invention and also essentially includes a spindle 10 and a turntable 20, wherein:

The spindle 10 is formed along the axial direction Y and includes a first flow channel section 12, a plurality of first cooling chambers 15 on the path of the first flow channel section 12 and connected to the first flow channel section 12, and a first recirculation section 14 parallel to the axial direction Y, the two ends of the first flow channel section 12 are respectively a flow channel inlet 121 and a flow channel outlet 122, the two ends of the first recirculation section 14 are respectively a first recirculation inlet 141 and a first recirculation outlet 142, and the first recirculation section 14 can be designed to be eccentric to the axis of the spindle 10 or to be arranged along the axis of the spindle 10; in this embodiment, the spindle 10 includes a spindle body 103 and an annular sleeve 104 sleeved on the spindle body 103, each of the first cooling chambers 15 is arranged between the spindle body 103 and the annular sleeve 104, the flow channel inlet 121 of the first flow channel section 12 is arranged on the annular side surface 102, and the flow channel outlet 122 is arranged on the top surface 101. In addition, the spindle 10 is pivoted on a plurality of distributors 30 arranged along the axial direction Y, a plurality of seals 40 are arranged between the spindle 10 and the distributors 30 along the axial direction Y, and each of the seals 40 is located beside a corresponding one of the first cooling chambers 15.

The turntable 20 is locked with the spindle 10, and includes a second flow channel section 21 connected to the flow channel outlet 122, a second cooling chamber 24 connected to the second flow channel section 21, and a second recirculation section 23 connected between the second cooling chamber 24 and the first recirculation inlet 141; in this embodiment, the second cooling chamber 24 is annular, but not limited thereto, and the second cooling chamber 24 can also be spiral (see the second embodiment), and includes a first chamber port 241 connected to the second flow channel section 21, and a second chamber port 242 far from the first chamber port 241 and connected to the second recirculation section 23, so that the length of the path of the cooling liquid flowing from the first chamber port 241 into the second cooling chamber 24 and then flowing out from the second chamber port 242 is the longest to obtain the best cooling effect. In addition, the turntable 20 is pivotally mounted on the bearing seat 90 by the bearing 80, and the bearing 80 corresponds to the second cooling chamber 24 of the turntable 20.

The above is a configuration description of the main components of the third embodiment of the present invention. The operation mode and effect of the present invention are described as follows.

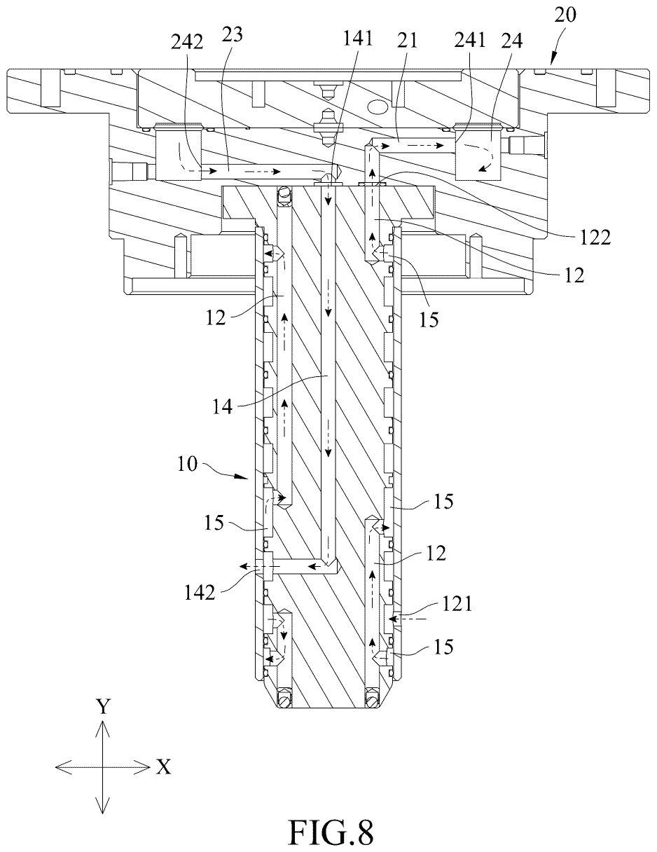

Referring to FIG. 8, it should be noted that the cooling circuit of the present invention is formed by the first flow channel section 12 of the spindle 10, the first cooling chambers 15 of the spindle 10, the second flow channel section 21 of the turntable 20, the second cooling chamber 24 of the turntable 20, the second recirculation section 23 of the turntable 20, and the first recirculation section 14 of the spindle 10.

Referring to FIG. 6 and FIG. 8, the cooling liquid (as indicated by the arrow) of the cooling circuit flows in a path such that the cooling liquid first flows from the flow channel inlet 121 of the first flow channel section 12 into the interior of the spindle 10 in the radial direction X, and flows radially X or axially Y along the bending design of the first flow channel section 12. During the flow of the cooling liquid in the first flow channel section 12, the cooling liquid flows through the first cooling chambers 15 corresponding to the respective seals 40, and then flows out of the spindle 10 from the flow channel outlet 122 and flows into the interior of the turntable 20 from the second flow channel section 21. After entering the turntable 20, the cooling liquid flows into the second cooling chamber 24 of the turntable 20 along the radial direction X, then flows out from the second recirculation section 23 of the turntable 20, and then flows back to the interior of the spindle 10 through the first recirculation section 14. Finally, the cooling liquid flows out through the first recirculation outlet 142 of the spindle 10, completing the entire cooling liquid circulation process.

It can be seen that the present invention forms an effective cooling circuit by providing the first flow channel section 12 and a plurality of first cooling chambers 15 connected to the first flow channel section 12 on the spindle 10, and the second cooling chamber 24 of the turntable 20 and the flow channel section design therebetween, so that each of the seals 40 of the rotary worktable 100 is located beside the corresponding one of the first cooling chambers 15, and the bearings 80 of the rotary worktable 100 correspond to the first cooling chambers 15. This design can effectively remove the heat generated by the seals 40, the bearings 80 and other components when the rotary worktable 100 is running at high speed, thereby suppressing the temperature rise of the entire rotary worktable 100 to maintain the normal operation of the rotary worktable 100, while ensuring that it can still maintain stable performance under long-term high-load operation, thereby improving the operating efficiency of the rotary worktable 100 and enhancing its service life.

What is claimed is:

1. A rotary worktable with a cooling circuit comprising:
a spindle formed along an axial direction and including a plurality of flow channel inlet sections, a plurality of first flow channel sections respectively connected to the flow channel inlet sections and arranged around the axial direction, a flow channel outlet section connected to the respective first flow channel sections, and a first recirculation section parallel to the axial direction, wherein two ends of the first recirculation section are respectively a first recirculation inlet and a first recirculation outlet; and
a turntable locked with the spindle and including a second flow channel section connected to the flow channel outlet, a cooling chamber connected to the second flow channel section, and a second recirculation section connected between the cooling chamber and the first recirculation inlet.

2. The rotary worktable with the cooling circuit as claimed in claim 1, wherein the spindle further includes a top surface and an annular side surface, each of the flow channel inlet sections includes a flow channel inlet located on the annular side surface, the flow channel outlet section includes a plurality of outlet flow sections respectively connected to the first flow channel sections and arranged in a radial pattern, and a converging flow section connected to the respective outlet flow sections, and the converging flow section has a flow channel outlet located on the top surface and connected to the second flow channel section.

3. The rotary worktable with the cooling circuit as claimed in claim 1, wherein the cooling chamber is annular or spiral-shaped and includes a first chamber port connected to the second flow channel section, and a second chamber port far from the first chamber port and connected to the second recirculation section.

4. The rotary worktable with the cooling circuit as claimed in claim 1, wherein the spindle is pivoted on a distributor, a plurality of seals are arranged between the spindle and the distributor along the axial direction, and each of the seals is within a length range of each of the first flow channel sections.

5. The rotary worktable with the cooling circuit as claimed in claim 4, wherein the distributor is embedded in a rotor, the rotor is embedded in a stator, a brake is arranged between the rotor and the stator, the brake is within a length range of each of the first flow channel sections, the turntable is pivotally mounted on a bearing seat by a bearing, and the bearing corresponds to the cooling chamber of the turntable.

6. The rotary worktable with the cooling circuit as claimed in claim 1, wherein the first flow channel sections are spaced equidistantly around the axial direction.

7. A rotary worktable with a cooling circuit comprising:
a spindle formed along an axial direction and including a first flow channel section, a plurality of first cooling chambers on the path of the first flow channel section and connected to the first flow channel section, and a first recirculation section parallel to the axial direction, the two ends of the first flow channel section are respectively a flow channel inlet and a flow channel outlet, the two ends of the first recirculation section are respectively a first recirculation inlet and a first recirculation outlet; and
a turntable locked with the spindle, and including a second flow channel section connected to the flow channel outlet, a second cooling chamber connected to the second flow channel section, and a second recirculation section connected between the second cooling chamber and the first recirculation inlet.

8. The rotary worktable with the cooling circuit as claimed in claim 7, wherein the spindle includes a spindle body and an annular sleeve sleeved on the spindle body, the first cooling chambers are arranged between the spindle body and the annular sleeve.

9. The rotary worktable with the cooling circuit as claimed in claim 7, wherein the second cooling chamber is annular or spiral-shaped and includes a first chamber port connected to the second flow channel section, and a second chamber port far from the first chamber port and connected to the second recirculation section.

10. The rotary worktable with the cooling circuit as claimed in claim 7, wherein the spindle is pivoted on a distributor, a plurality of seals are arranged between the spindle and the distributors along the axial direction, each of the seals is located beside a corresponding one of the first cooling chambers, the turntable is pivotally mounted on a bearing seat by a bearing, and the bearing corresponds to the second cooling chamber of the turntable.
